(19) United States
(12) Patent Application Publication
(10) Pub. No.: US 2026/0002808 A1
(43) Pub. Date: Jan. 1, 2026

(54) CAPACITIVE SENSOR

(71) Applicant: CEBI ELECTROMECHANICAL COMPONENTS SPAIN, S.A., Villatuerta (Navarra) (ES)

(72) Inventors: Jorge MACHÍN MINDÁN, Villatuerta (Navarra) (ES); Enrique BRETÓN CRISTÓBAL, Villatuerta (Navarra) (ES); Javier GARCÍA IZAGUIRRE, Villatuerta (Navarra) (ES); Sergio DÍEZ GARCÍA, Villatuerta (Navarra) (ES)

(21) Appl. No.: 19/249,255

(22) Filed: Jun. 25, 2025

(30) Foreign Application Priority Data
Jun. 28, 2024 (ES) U202431239

(51) Int. Cl. G01F 23/263

(52) U.S. Cl. CPC G01F 23/263

(57) ABSTRACT

A capacitive sensor comprising a base plate (1) which is housed in a cover casing (2), the base plate (1) being electrically connected to terminals (5) of an external connector (3) by connection springs (4), wherein the connection springs (4) for connecting the base plate (1) to the terminals (5) are arranged in a spring holder (6), which establishes a guided coupling with the base plate (1), and the spring holder (6) with fasteners that establish a first interlock in the base plate (1) in a pre-assembly position with the connection springs (4) at rest, and a second interlock in a final operative fastening position with the connection springs (4) compressed inside the spring holder (6) by pushing the external connector (3) so that it closes on the cover casing (2).

### CROSS-REFERENCE TO RELATED APPLICATIONS

This application claims the benefit of priority from Spanish Application No. U202431239 filed on Jun. 28, 2024, the contents of which is incorporated herein by reference in its entirety.

### TECHNICAL FIELD

The present invention relates to sensors used for applications such as controlling the level of liquids in containers or tanks, more specifically in systems for measuring the level of liquids in tanks in the automotive sector, in which the measurement standards are more demanding in terms of accuracy, proposing a capacitive-type sensor for these applications, having features that facilitate assembly and improve the structural conditions to avoid problems that may cause errors in the functional behaviour of the measurements to be taken in the application uses of the sensor.

### STATE OF THE ART

Capacitive sensors made of laminated material are currently known on the market and they consist of a base plate electrically connected to an external connecting connector and housed inside a cover casing, said base plate comprising an electronic assembly by means of which the level of a liquid can be detected based on the capacitance between electrodes depending on whether they are in the air or immersed in the liquid to be measured.

Said sensors are also known to connect the terminals of the external connector to the base plate by means of springs, which must be compressed during the assembly process to ensure electrical contact.

To assemble the connection springs, the springs are conventionally arranged initially stretched, in order to be compressed in the assembly process, which results in the springs falling out during handling of the assembly, the coils of said springs getting caught during compression or the springs buckling and their end being outside the contact area with the terminals of the external connector, resulting in a defective assembly in any of these cases.

Consequently, in the assembly process of the capacitive sensor, in order to make the connection between the terminals of the external connector and the base plate, the positioning and securing of the connection springs requires proper centring and fastening to prevent the springs from falling out of their pre-assembly position or buckling during their compression into the assembly position.

Furthermore, the base plate of the capacitive sensors, which is made of laminated material, has a high coefficient of expansion and can generate buckling deformations in thermal expansion, which affects the calibration of the sensor and can even cause component parts of the structural assembly to become uncoupled from the sensor. As such, to avoid this problem, there must be a longitudinal clearance between the base plate and the cover casing so that the base plate can expand inside the casing in the assembled sensor assembly.

Therefore, there is a clear need for a capacitive sensor that allows quick and safe assembly of the component assembly and provides structural conditions that avoid problems that could affect the functional behaviour of the sensor.

### OBJECT OF THE INVENTION

According to the present invention, a capacitive sensor developed according to an embodiment is proposed which provides advantageous constructive and functional features, both for the constructive assembly and for avoiding problems that may affect the proper functioning of the sensor.

The capacitive sensor of the invention comprises, as in conventional embodiments, a base plate incorporating an electronic assembly capable of measuring the capacitance between electrodes based on the medium in which they are located, said base plate being arranged inside a cover casing and connected by means of springs to the terminals of an external connector.

According to the invention, the connection springs for connecting the base plate and the terminals of the external connector are arranged in a spring holder, which defines housings in which the springs are inserted, allowing them to be secured in a predetermined assembly position. Said spring holder further establishes a guided coupling with the base plate, and comprises fastening means establishing a first interlock in the base plate in a pre-assembly position with the connection springs at rest, and establishes a second interlock in a final operative fastening position with the connection springs compressed inside said spring holder by pushing the external connector so that it closes on the cover casing.

This ensures that the connection springs remain secured during the assembly process, thus facilitating the assembly operation, as the spring holder fits into the base plate in a guided manner, and by establishing a first pre-assembly position, it prevents the springs from falling out or being dislodged from their position due to handling during the assembly process. The springs are guided in the housings of the spring holder, which, as the springs are compressed lengthwise, prevents them from buckling or their coils from getting caught, resulting in poor positioning during assembly, and once the position has been secured by pushing the connector until it closes on the casing, said final position is established. In this way, easy and safe assembly of the capacitive sensor is achieved, the connection springs being compressed between the base plate and the terminals of the external connector, so that the push of the springs ensures electrical communication of the connection, while the base plate remains in a floating arrangement that absorbs the dimensional variations of said base plate due to expansions caused by the temperature, at the same time that it maintains the relative position of the base plate inside the cover casing, preventing contact between them.

Preferably, to guide coupling of the spring holder on the base plate, said spring holder comprises a groove with a geometry corresponding to the base plate, so that during assembly the positioning is facilitated to reach the pre-assembly position and the subsequent final assembly position.

To transition the spring holder between the pre-assembly position, with the connection springs stretched, and the final assembly position, with said connection springs compressed, the fastening means are at least one flexible pin and preferably two pins, one on each side of the spring holder and comprising a protrusion at the distal end, while the base plate has recesses at two different distances from the end of said base plate at its side, having a geometry corresponding to the protrusion of the pins of the spring holder. Thus, for fastening in the pre-assembly position by pushing the spring holder onto the base plate, the flexible pin with its protrusion fits into the recess closest to the end of the base plate, and for fastening in the final position, the connector is pressed until it closes so that the protrusion fits into the recess furthest away from the end of the base plate.

This feature results in a first temporary fitting interlock in the pre-assembly position and a second retaining interlock in the final assembly position, between which the external connector can be displaced by simple pushing, the external connector being pushed on the connection springs during this displacement to compress them lengthwise to the final assembly position.

To ensure assembly of the capacitive sensor component assembly, with the connection springs between the base plate and the compressed terminals in a position that ensures electrical contact on the terminals of the external connector, the casing that houses the base plate and the external connector have reciprocal formations, the external connector comprising at least two openings, and the casing comprising at least one projecting flange reciprocal to each opening, by means of which an assembly retaining fit is established between the external connector and the cover casing. It is also envisaged that the openings will be provided in the casing and the corresponding flanges will be provided on the external connector, as long as the intended elastic fit is achieved.

This configuration establishes the closure of the capacitive sensor by pressing it to the stop, thus ensuring that the assembly is retained against the push of the compressed connection springs, i.e., establishing a retention in the longitudinal direction of the sensor.

This longitudinal retaining fit sometimes allows a certain amount of rotation between the casing and the external connector due to the clearances required for a proper fit, with the walls of the openings being preferably thin, and there is a risk that they may break and the respective rotation may also affect the sensing capability of the sensor. It is therefore envisaged that the external connector comprises at least one recess or projection on the inner surface of the outer edge of the external connector that interacts with a reciprocal projection or recess on the outer surface of the casing to act as an anti-rotation retaining fit of the assembly.

Preferably, the connector comprises two diametrically opposed recesses corresponding to two projections of the casing, said recesses having different dimensions to define a single fastening position (poka-yoke) to ensure correct assembly.

Furthermore, the sensor of the invention comprises lateral centring means for laterally centring the base plate with respect to the casing, said means being formations at the bottom of the casing corresponding to formations at the end of the base plate which, when the base plate is inserted into the casing, cause it to be laterally centred.

This configuration centres the base plate, allowing some clearance between the side edges of the base plate and the casing, since, if the sides were to touch, the base plate would bend upon being touched in the event of expansion, buckling in a cylindrical shape that would affect the measurement accuracy of the sensor.

Preferably, the geometry corresponding to both formations will preferably be V-shaped. In this way, accurate and stable centring of the base plate with respect to the casing is achieved during the insertion of the base plate, so that in its final position the lateral distance between the plate and the casing that could alter the calibration of the sensor is maintained, and a precise vertical movement is achieved so that the springs correctly absorb possible expansions.

Moreover, the casing preferably comprises on its inner surface at least one longitudinal rib configured to position the sensitive face of the base plate in contact with the casing in the final assembly position. In other words, the longitudinal rib shall be arranged opposite the sensitive part of the sensor casing, so that the electrodes are arranged as close as possible to the casing in the final assembly.

This configuration obtains greater measurement accuracy, since, given that the plastic of the casing acts as a dielectric, its thickness is controlled to take it into account in the measurement, and if there is a separation between the casing and the electrode, and the air between the two elements would also act as a dielectric, affecting the measurement accuracy.

In view of the foregoing, this capacitive sensor of the invention has advantageous features for its assembly and functional behaviour, acquiring a life of its own and being preferred with respect to the capacitive sensors that are known for use in the same applications.

### DESCRIPTION OF THE FIGURES

FIG. 1 shows an exploded perspective view of the component assembly of an exemplary capacitive sensor according to the object of the invention.

FIG. 2 is a sectional front view of the base plate of the capacitive sensor, with the springs for connecting to the external connector of the sensor being arranged in a pre-assembly position with respect to said base plate.

FIG. 3 is a sectional front view of the capacitive sensor of FIG. 1 in a final assembly position.

FIG. 4 is a sectional side view of the assembled capacitive sensor.

FIG. 5 is a perspective view of the spring holder of the invention.

FIG. 6 is an enlarged perspective detail of the coupling between the external connector and the casing that houses the base plate on the capacitive sensor.

FIG. 7 shows a perspective view of the casing without the base plate.

FIG. 8 shows a top view of the casing where the longitudinal ribs can be seen.

FIG. 9 shows a bottom view of the external connector.

FIG. 10 is a cross-section detail of the bottom of the assembled assembly.

### DETAILED DESCRIPTION OF THE INVENTION

The subject matter of the invention relates to a capacitive sensor for use, for example, as a meter for measuring the level of liquids in containers or tanks, without ruling out other possible applications of use.

This disclosed capacitive sensor comprises a base plate (1) formed by layers of laminated material, said base plate (1) incorporating an electronic assembly capable of detecting the capacitance between electrodes (not shown) based on the medium in which they are located, such as air or a liquid which level is to be measured.

The base plate (1) is arranged inside a cover casing (2), mounted with an electric connection, by means of connection springs (4), with respect to the terminals (5) of an external connector (3), which is incorporated as a closing cap on the mouthpiece of the aforementioned cover casing (2).

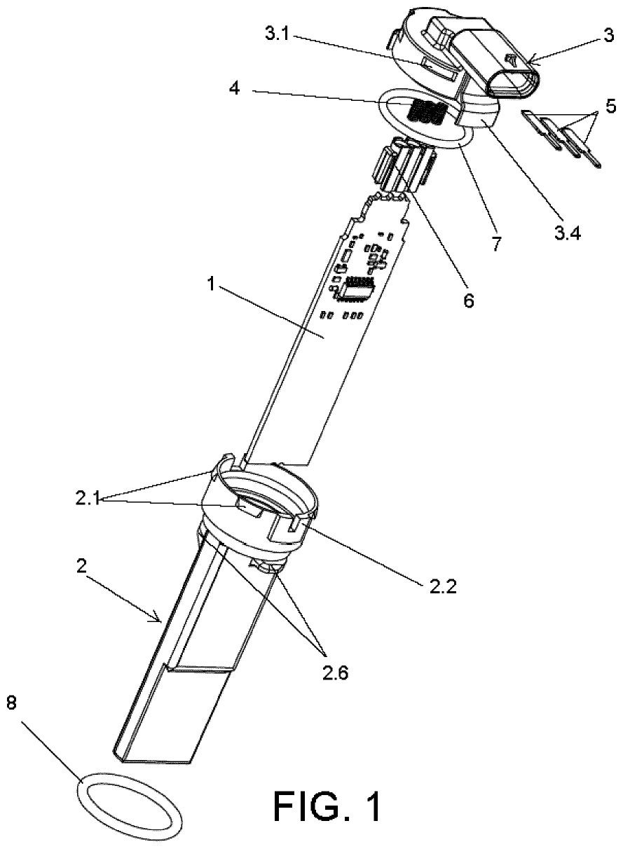

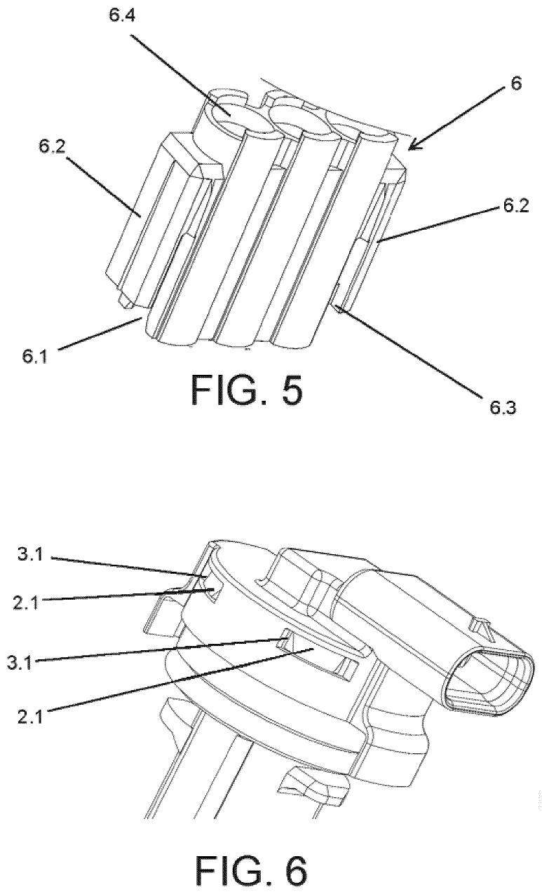

In particular, according to the invention, the connection springs (4) for electrically connecting the base plate (1) and the external connector (3) are arranged through a spring holder (6) as can be seen in FIG. 1 prior to assembly. As can be seen in FIG. 5, said spring holder (6) defines cylindrical housings (6.4) lengthwise in which the springs (4) are included, so that to assemble the capacitive sensor, said springs (4) are placed passing through the spring holder (6), with one end in contact with metallised surfaces on the edge of the base plate (1), protruding at the other end with respect to said spring holder (6), in order to be compressed by pushing the external connector (3) when said external connector (3) is placed in coupling assembly on the mouthpiece of the cover casing (2), so that the springs (4) are thus compressed lengthwise inside the spring holder (6), without buckling or being poorly positioned, being pressed on the terminals (5) of the external connector (3) with the necessary force to establish good electrical contact.

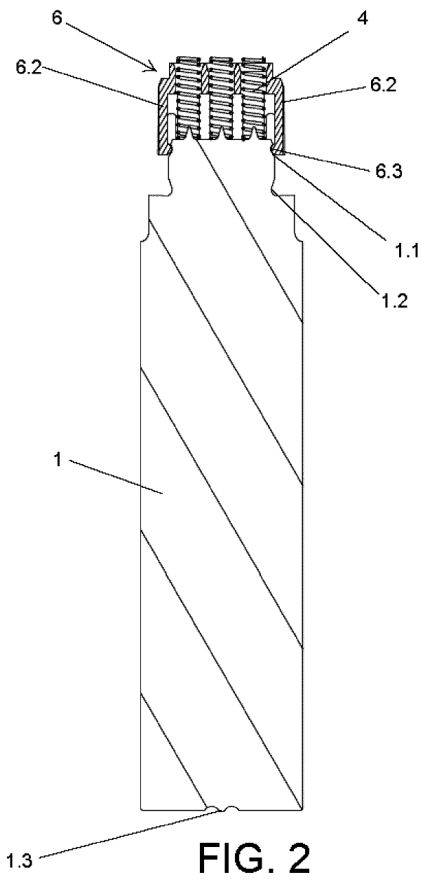

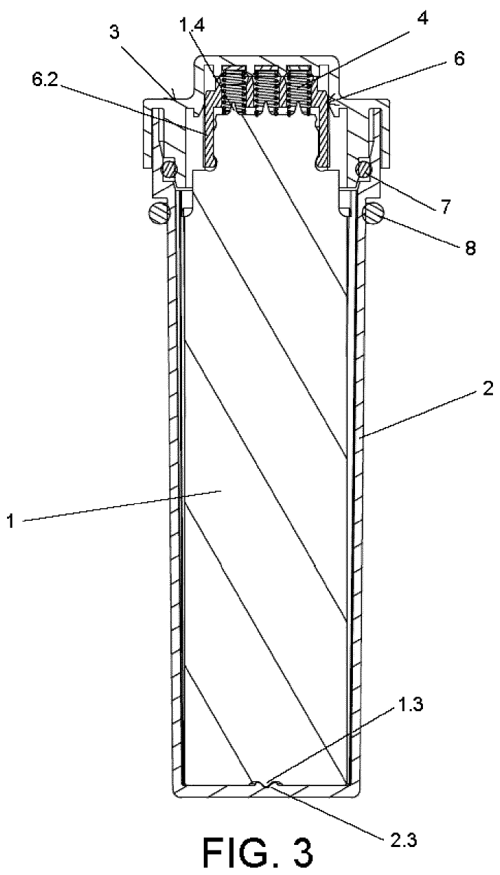

To assemble the connection springs (4), the spring holder (6) has flexible pins (6.2), which have a protrusion (6.3) at the distal end, while the base plate (1) has recesses (1.1, 1.2) at two different distances from the end of said base plate (1) in the end area. To assemble the connection springs (4), the spring holder (6) is first positioned with the protrusions (6.3) of its side flexible pins (6.2), fitted into the recesses (1.1) closest to the end of the base plate (1), the springs (4) being incorporated in this position through the spring holder (6) to the base plate (1), reaching a first pre-assembly position as can be seen in FIG. 2. When the external connector (3) is coupled, it compresses the springs (4) on the inside of the spring holder (6) and at the same time pushes said spring holder (6) so that the protrusions (6.3) of its flexible pins (6.2) become interlocked in the recesses (1.2) furthest away from the end of the base plate (1), pushing the external connector (3) into the locked position and, as shown in FIG. 3, fastening the spring holder (6) in the final assembly position. This facilitates the process of assembling the springs (4) in the correct position and without buckling, allowing the base plate (1) to remain in a floating position inside the casing (2), which allows expansions to be absorbed without buckling of the base plate (1).

In order to position the springs (4) more precisely in contact with the base plate (1), the end of the base plate (1) comprises angled projections (1.4) on its edge into which the springs (4) fit, and for better electrical contact, the end of the base plate (1) comprises a metallised edge.

To ensure the closure between the external connector (3) and the casing (2), the external connector (3) comprises openings (3.1) distributed along the perimeter, preferably evenly spaced apart. In turn, the casing (2) comprises flanges (2.1) corresponding to said openings (3.1) in the form of projections, between which a snap fit is established that ensures the retention in the longitudinal direction of assembly of the external connector (3) with respect to the cover casing (2), in the coupling between the two. This is a practical exemplary embodiment of said closure, however, the flanges (2.1) can be indistinctly on the external connector (3) and on the cover casing (2), without altering the concept of the retention for assembling the external connector (3) on the cover casing (2), as shown in FIG. 6.

According to the practical embodiment shown in the figures, the connector (3) also has two recesses (3.2) in the inner surface of the outer edge of the connector (3), preferably diametrically opposed, which interact with projections (2.2) having a geometry corresponding to said recesses (3.2). Thus, when fitting the connector (3) on the casing (2), the flanges (2.1) fit into the openings (3.1) preventing their relative longitudinal movement, and at the same time, by fitting the projections (2.2) into the recesses (3.2), an anti-rotation device is formed to prevent angular displacements between the connector and the casing. Preferably, the recesses (3.2) will have different dimensions or geometry, so that there is only one fastening position between connector (3) and casing (2) that ensures correct contact between base plate (1) and terminals (5).

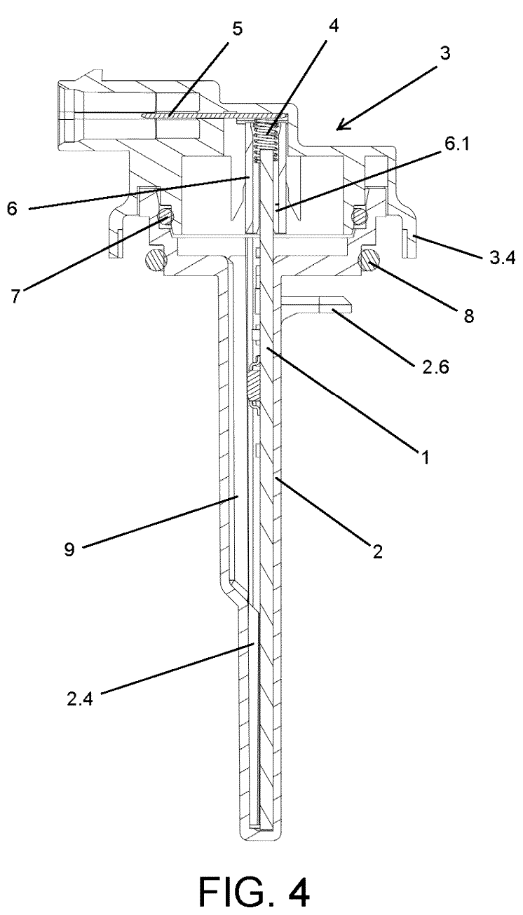

According to the practical embodiment, in order to maintain the position of the base plate (1) inside the cover casing (2) with a constant dielectric separation, since the proper functioning of the capacitive sensor depends on it, the base plate (1) has, at the end facing the bottom of the cover casing (2), formations (1.3) that fit into corresponding formations (2.3) generated at the bottom of the cover casing (2). As can be seen in FIGS. 3 and 4, and in more detail in FIG. 10, the formations (1.3) of the end of the base plate (1) consist of two recesses that generate an inverted V-shaped centred intermediate projection, while the formations (2.3) of the bottom of the casing (2) are two projections that generate a V-shaped indentation corresponding to the intermediate projection of the formations (1.3) of the base plate (1). Thus, during the assembly process, when the base plate (1) is inserted into the casing (2), the corresponding formations (1.3, 2.3) guide the base plate (1) into a centred position, leaving some clearance of the side edges of the base plate (1) with respect to the casing (2). In this way, a retention is established that prevents the base plate (1) from displacing laterally and centres the same, in order to maintain it in its distanced position with respect to the cover casing (2).

As can be seen in FIG. 4, the cover casing (2) defines a widening (9) in which the electronic assembly of the base plate (1) is housed.

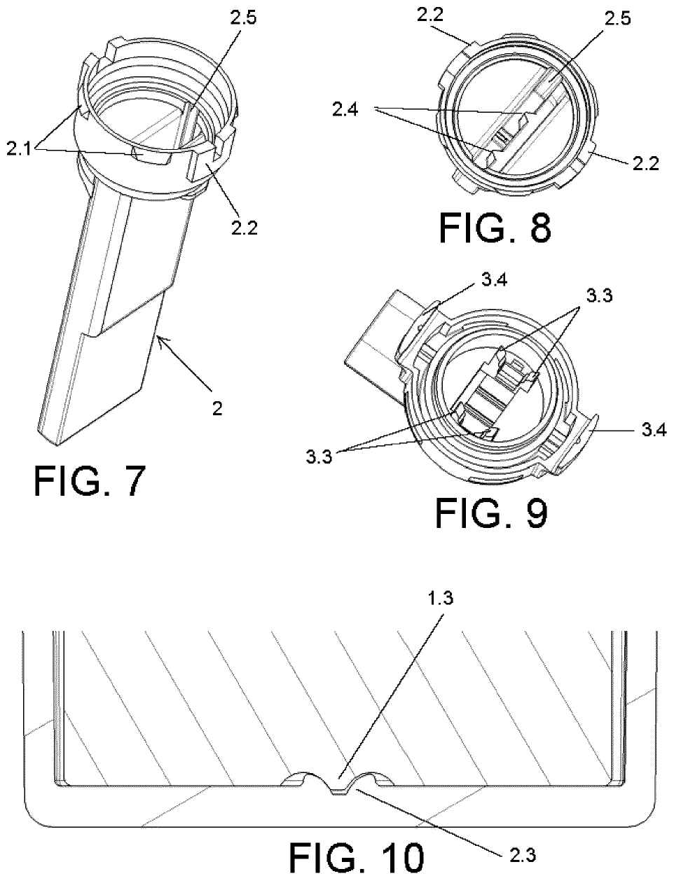

Additionally, according to the preferred embodiment shown in the figures, the casing (2) comprises a longitudinal rib (2.4) and preferably two longitudinal ribs (2.4) following the aforementioned widening (9) of the casing (2), in other words, on the inner side of the casing (2) opposite the sensitive surface of the sensor. Said longitudinal ribs (2.4) have an initial angled geometry to guide the base plate (1) during its insertion into the casing (2). Thus, as can be seen in FIG. 7, the casing has a guide groove (2.5) that positions the base plate (1) for its correct insertion, and subsequently, by means of the longitudinal ribs that can be seen in FIG. 8, the base plate (1) is directed transversely to the casing (2) so that the measuring electrodes are in contact with the casing (2) in order to reduce the air between the casing (2) and the electrodes as much as possible, which could affect the measurement accuracy.

As can be seen in FIG. 9, according to a preferred embodiment, the external connector (3) comprises inclined flanges (3.3) on its lower part, which facilitate the fitting of the base plate (1) for its retention.

Each of the aforementioned features provides greater robustness to the sensor assembly once assembled and contributes to improving measurement accuracy by preventing buckling of the base plate (1) and minimising the air between the sensor surface and the casing.

Additionally, to ensure the sealing of the assembled capacitive sensor assembly, there is a sealing gasket (7) between the external connector (3) and the casing (2) that houses the base plate (1), said sealing gasket protecting the interior from external elements, as shown in FIGS. 3 and 4, while, to seal the capacitive sensor in the application assembly, there is another sealing gasket (8) around the casing (2) in the coupling area of the application assembly. Furthermore, to assemble the casing on the tank for which it is intended, the casing (2) comprises flaps (2.6), which allow bayonet mounting that corresponds to the geometry of the assembly opening of the tank, the connector (3) also having flaps (3.4) that fit during bayonet rotation assembly to secure the position.

1. A capacitive sensor comprising a base plate (1) which is housed in a cover casing (2), said base plate (1) being electrically connected to terminals (5) of an external connector (3) by means of connection springs (4) for connecting the base plate (1) to the terminals (5), wherein the connection springs (4) are arranged in a spring holder (6), which establishes a guided coupling with the base plate (1), and the spring holder (6) with fastening means that establish a first interlock in the base plate (1) in a pre-assembly position with the connection springs (4) at rest, and a second interlock in a final operative fastening position with the connection springs (4) compressed inside said spring holder (6) by pushing the external connector (3) thereby closing on the cover casing (2).

2. The capacitive sensor according to claim 1, wherein the coupling guide on the base plate (1) is established with a groove (6.1) of the spring holder (6) corresponding to the geometry of the base plate (1).

3. The capacitive sensor according to claim 1, wherein the fastening means are at least one flexible pin (6.2) of the spring holder (6) comprising a protrusion (6.3) at a distal end, while the base plate (1) has recesses (1.1) at two different distances from an end of said base plate (1) on at least one of its sides and having a geometry corresponding to the protrusion (6.3), so that, for fastening in the pre-assembly position, the at least one flexible pin (6.2) fits into the recesses (1.1) closest to the end of the base plate (1), and for fastening in the final position, the external connector (3) is pressed until it closes so that the protrusion (6.3) fits into the recess (1.2) furthest away from the end of the base plate (1).

4. The capacitive sensor according to claim 1, wherein to close the external connector (3) with the casing (2), said external connector (3) comprises at least two substantially diametrically opposed openings (3.1), the casing comprising at least one projecting flange (2.1) reciprocal to each opening (3.1), by means of which an assembly retaining fit is established between the external connector (3) and the cover casing (2).

5. The capacitive sensor according to claim 1, wherein the external connector (3) comprises at least one recess/projection (3.2) on an inner surface of an outer edge of the external connector (3), which interacts with a reciprocal projection/recess (2.2) on an outer surface of the cover casing (2) to act as an anti-rotation retaining fit of the assembly.

6. The capacitive sensor according to claim 1, comprising lateral centring means for laterally centring the base plate (1) with respect to the casing (2) by means of formations (2.3) at a bottom of the casing (2) corresponding to formations (1.3) at a free end of the base plate (1) which, when the base plate (1) is inserted, cause it to be laterally centred in the casing (2).

7. The capacitive sensor according to claim 6, wherein the formations of the bottom of the casing (2) have a V-shaped configuration corresponding to a V-shaped configuration of the base plate (1) that establishes a centring fit in the final assembly position.

8. The capacitive sensor according to claim 1, wherein the casing (2) comprises on its inner surface at least one longitudinal rib (2.4) configured to position the sensitive face of the base plate (1) in contact with the casing (2) in the final assembly position.

9. The capacitive sensor according to claim 1, wherein a first sealing gasket (7) is arranged in the coupling between the external connector (3) and the cover casing (2).

10. The capacitive sensor according to claim 1, wherein a second sealing gasket (8) is arranged around the cover casing (2) in the coupling area of the application assembly.
